(19) United States
(12) Patent Application Publication
(10) Pub. No.: US 2017/0299259 A1
(43) Pub. Date: Oct. 19, 2017

(54) DISPLAY UNIT FOR DISPENSER OF REFRIGERATOR AND METHOD FOR MANUFACTURING THE SAME

(71) Applicant: Dongbu Daewoo Electronics Corporation, Seoul (KR)

(72) Inventor: Sung Hwan LEE, Seoul (KR)

(21) Appl. No.: 15/474,815

(22) Filed: Mar. 30, 2017

(30) Foreign Application Priority Data
Apr. 19, 2016 (KR) 10-2016-0047745

(51) Int. Cl. F25D 29/00; B32B 15/04; F25D 23/12; B32B 27/06; F25D 23/02

(52) U.S. Cl. CPC F25D 29/005; B32B 27/06; F25D 23/028; F25D 23/126; B32B 15/04; B32B 2307/412; B32B 2457/20; F25D 2400/361; B32B 2509/10

(57) ABSTRACT

A method of manufacturing a display unit used on a refrigerator is provided. The method includes forming an inlay film into a predetermined shape, disposing the inlay film at a first side of a mold and disposing one or more light-transmitting transparent components at a second side of the mold, and injecting a resin into the mold to bond the inlay film and the transparent components. A resultant one-piece-molded article is the removed from the mold and integrated with a substrate having a light source.

### CROSS-REFERENCE TO RELATED APPLICATION

This application is based on and claims priority from Korean Patent Application No. 10-2016-0047745, filed on Apr. 19, 2016, the disclosure of which is incorporated herein in its entirety by reference for all purposes.

### TECHNICAL FIELD

Embodiments of the present disclosure relate to refrigerators, and more particularly, to user interface displays devices in refrigerators and manufacturing methods of the same.

### BACKGROUND

A refrigerator is an appliance used for storing food at a low temperature and may be configured to store food (or other items) in a frozen state or a refrigerated state. The inside of the refrigerator is cooled by circulating cold air that can be continuously generated through a heat exchange process by using a refrigerant. During operation, the refrigerant goes through repetitive cycles of compression, condensation, expansion and evaporation in a heat exchanger. Cold air supplied in the refrigerator is uniformly distributed by convection. Accordingly, items placed in the refrigerator can be stored at a desired low temperature.

A main body of the refrigerator may have a rectangular parallel-piped shape with an open front surface. Typically, the main body encloses a refrigeration compartment and a freezer compartment, each with its own door. The refrigerator may include a plurality of drawers, shelves, vegetable compartments, etc., for sorting different types of items.

Conventionally, top mount type refrigerators used to be popular, with a freezer compartment located at an upper side and a refrigeration compartment located at a lower side. Recently, bottom freezer type refrigerators have been developed, where a freezer compartment is located at the lower side. A bottom freezer type refrigerator provides the advantage that user can conveniently access the refrigerator in general. However, a user often needs to lower down or bend down to access the freezer compartment, e.g., for taking ice from it.

Some bottom freezer type refrigerators have an ice dispenser located at the refrigeration compartment disposed at the upper side of the refrigerator. An ice-making device for making ice pieces may be disposed on the refrigeration compartment door or inside refrigeration compartment.

A display unit may be mounted on the door for displaying operational states of such a dispenser. Conventionally, various parts in a display unit are manufactured separately and then integrated together, including a molding that serves as a housing of the display unit, a film used to provide a specific color or texture of displayed information, and an internal component (e.g., a light-transmitting transparent component). During integration, the film is attached to the outer surface of the molding by using a double-side tape for example. The internal component is installed in a designated position of the molding in a different process.

Unfortunately, this approach requires extended manufacturing time. Furthermore, as the various components are combined and assembled together, assembly tolerances are inevitable, which can mar the display unit. Consequently, the appearance of the display units may lack unity and may be unsatisfactory to users or potential users.

### PRIOR ART DOCUMENTS

### Patent Documents

Patent Document 1: Korean Patent Application Publication No. 10-2012-84214 (published on Jul. 27, 2012)

### SUMMARY

Embodiments of the present disclosure provide a display unit for a dispenser in a refrigerator that can be manufactured in a single injection molding process. A resultant display unit offers the advantages of improved exterior design with enhanced unity.

In accordance with an embodiment of the present disclosure, a method of manufacturing a display unit on a refrigerator includes: an inlay film forming process of forming an inlay film having a predetermined shape; a component disposing process of disposing the inlay film at a first side of a mold and disposing one or more light-transmitting transparent components at a second side (opposite to the first side) of the mold; a one-piece injection molding process of injecting a resin into the mold so that the inlay film and the transparent components are combined together and molded into a one-piece-molded article as the resin is cured; and a removal process of removing the one-piece-molded article from the mold.

Further, the inlay film forming process may include a step of placing a film raw material on a vacuum forming machine having a predetermined shape, a step of heating the film raw material and forming the film raw material into the inlay film in the predetermined shape; and a step of trimming an edge of the inlay film.

Further, the inlay film may include an ABS resin layer; a primer layer laminated on the ABS resin layer and configured to serve as an adhesive agent; a transparent layer laminated on the primer layer and configured to allow light to pass therethrough; a transparent metal printing layer laminated on the transparent layer for providing the visual effect of a metallic texture; and a clear coating layer laminated on the metal printing layer and made of a transparent material for protecting the metal printing layer.

Further, the method described above may further include a pattern forming process of forming a pattern, which is to be imprinted on a surface of the inlay film after the one-piece-molded article is injection-molded, on the first side of the mold in which the inlay film is disposed.

Further, a substrate having a light source is assembled with the one-piece-molded article.

### BRIEF DESCRIPTION OF THE DRAWINGS

FIG. 1 is a perspective view illustrating the configuration of a refrigerator with an exemplary display unit according to one embodiment of the present disclosure.

FIGS. 2A to 2D illustrate an exemplary inlay film forming process in manufacturing a display unit according to one embodiment of the present disclosure.

FIGS. 3A to 3D illustrate an exemplary process of manufacturing a display unit according to one embodiment of the present disclosure.

FIG. 4 is a perspective view illustrating an exemplary display unit manufactured by the method illustrated in FIGS. 3A to 3D.

FIG. 5 illustrates an exemplary process of assembling the display unit in FIG. 4 and a substrate provided with a light source.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

One or more exemplary embodiments of the present disclosure will be described more fully hereinafter with reference to the accompanying drawings, in which one or more exemplary embodiments of the disclosure can be easily determined by those skilled in the art. As those skilled in the art will realize, the described exemplary embodiments may be modified in various different ways, all without departing from the spirit or scope of the present disclosure, which is not limited to the exemplary embodiments described herein.

It is noted that the drawings are schematic and are not necessarily dimensionally illustrated. Relative sizes and proportions of parts in the drawings may be exaggerated or reduced in size, and a predetermined size is merely exemplary and not limiting. The same reference numerals designate the same structures, elements, or parts illustrated in two or more drawings in order to exhibit similar characteristics.

The exemplary drawings of the present disclosure illustrate ideal exemplary embodiments of the present disclosure in more detail. As a result, various modifications of the drawings are expected. Accordingly, the exemplary embodiments are not limited to a specific form of the illustrated region, and for example, may include modification due to manufacturing.

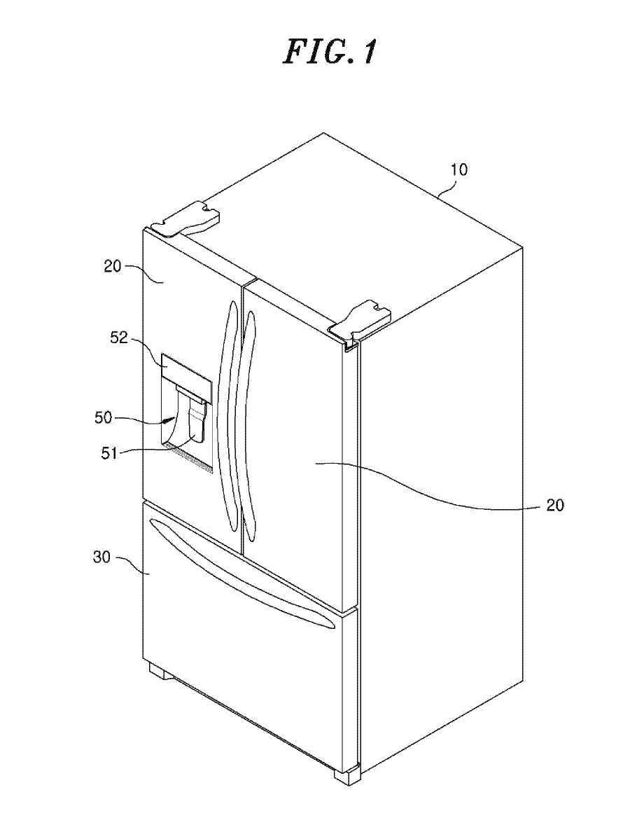

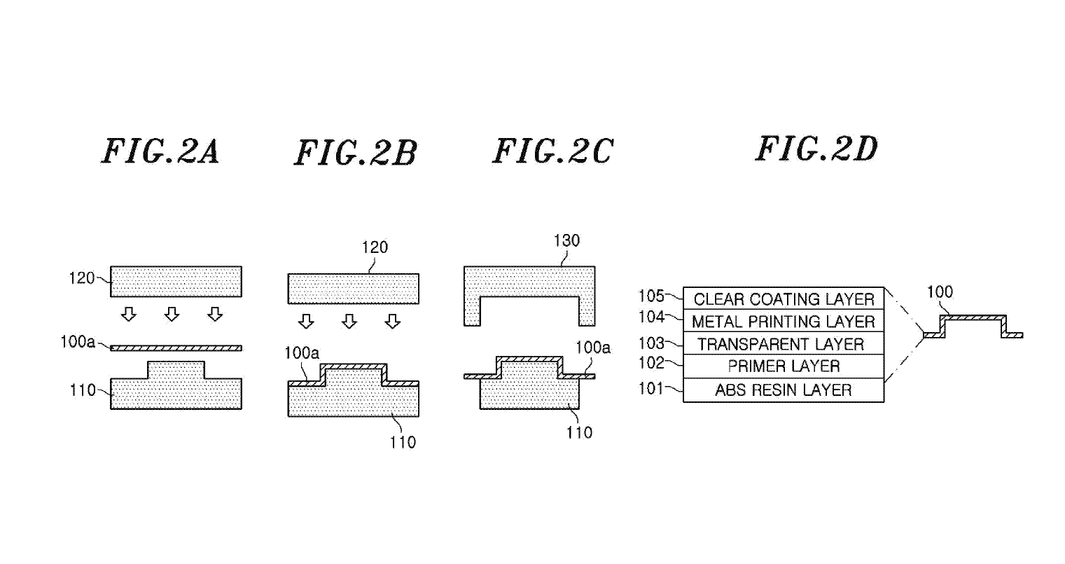

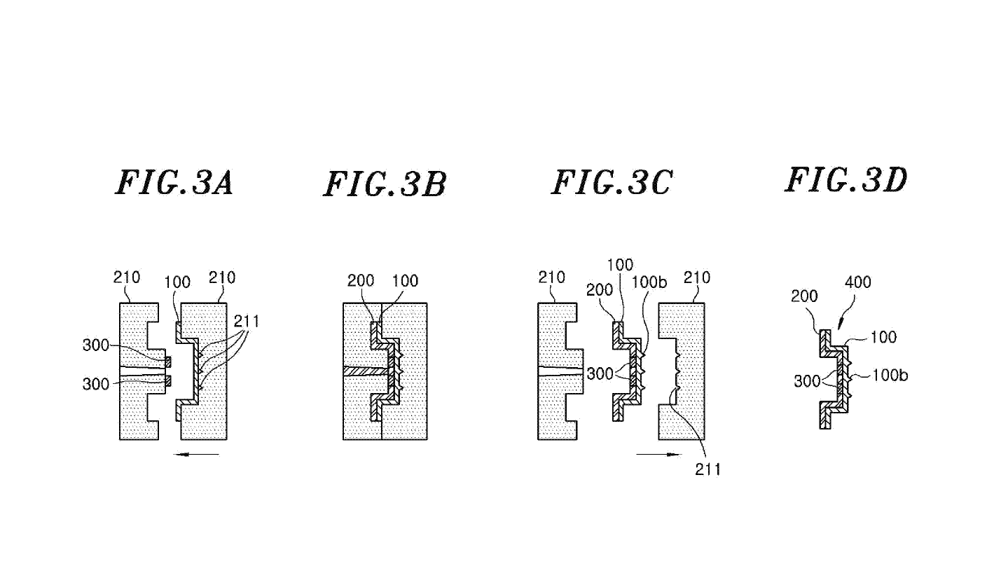

FIG. 1 is a perspective view illustrating the configuration of a refrigerator with an exemplary display unit according to one embodiment of the present disclosure. FIGS. 2A to 2D illustrate an exemplary inlay film forming process in manufacturing a display unit according to one embodiment of the present disclosure. FIGS. 3A to 3D illustrate an exemplary process of manufacturing a display unit according to one embodiment of the present disclosure.

Referring to FIGS. 1 to 3D, manufacturing a display unit for a dispenser in a refrigerator according to one embodiment of the present disclosure may include an inlay film forming process, a component disposing process, a one-piece injection molding process and a removal process.

Inclusion of the above-listed components in one embodiment of the present disclosure does not mean that the embodiment consists of only the components but means rather that the embodiment basically includes the components. The embodiment may further include other components (e.g., components well-known in the field of a method for manufacturing a display unit). Well-known components will not be described herein because they may obscure aspects of the present disclosure.

The embodiment of the present disclosure may be applicable to different kinds of refrigerators provided with a dispenser regardless of the kind and shape of refrigerator. For the sake of convenience in description and understanding, a bottom-freezer-type refrigerator will be illustrated and described by way of example. However, the present disclosure is not limited thereto.

As illustrated in FIG. 1, a refrigerator main body 10 has an approximately rectangular parallelepiped shape and includes a storage space.

The storage space of the refrigerator main body 10 may be divided into a refrigeration compartment and a freezer compartment, one above the other. Cold air is supplied to the refrigeration compartment and the freezer compartment to maintain low temperatures therein, e.g., suitable for refrigerating and freezing food.

The doors are configured to seal the refrigeration compartment and the freezer compartment. A rotatable door 20 may be mounted to the upper portion of the refrigerator main body 10. A drawer-type door 30 may be mounted to the lower portion of the refrigerator main body 10, which can slide in and out.

A dispenser 50 may be installed at one side of the door (e.g., the rotatable door 20). For example, responsive to user interactions, the dispenser 50 may dispense water purified in the refrigerator and ice produced therein. The dispenser 50 is disposed in a recess on the door.

A lever 51 is disposed in the dispenser 50. When a user presses the lever, water or ice can be dispensed. A platform for supporting a user's container may be located in the lower portion of the dispenser 50.

The dispenser 50 has a display unit 52, which can display operational information related to the dispenser 50 and other information of the refrigerator.

Hereinafter, the exemplary method of manufacturing the display unit is described with reference to FIGS. 2A to 3D.

As illustrated in FIGS. 2A to 2D, in the inlay film forming process, an inlay film 100 having a predetermined shape is formed. The term “predetermined shape” used herein refers to a shape corresponding to the shape of the display unit as designed.

More specifically, in the inlay film forming process, a vacuum forming machine 110 having a shape (predetermined shape) corresponding to the shape of the display unit 52 is provided and a film raw material 100a is placed on the vacuum forming machine 110 (FIG. 2A). Thereafter, once the film raw material 100a is heated by a heater unit 120, the film raw material 100a can form the shape defined by the vacuum forming machine 110 (FIG. 2B). The edge of the inlay film 100 can be trimmed to a suitable size (FIG. 2C), e.g., punched and removed using a punching machine 130. Thus, the inlay film 100 having the predetermined shape is manufactured (FIG. 2D).

The inlay film 100 constitutes the outermost layer of the display unit 52. The inlay film 100 may be made of a light-transmitting transparent material so that various numbers, text, or other symbols can be displayed through the display unit 52. Furthermore, the inlay film 100 may have a metallic texture. More specifically, the inlay film 100 may include an ABS (acrylonitrile-butadiene-styrene) resin layer 101, a primer layer 102, a transparent layer 103, a metal printing layer 104 and a clear coating layer 105, which are laminated one above another.

In this case, the primer layer 102 may be laminated on and bonded to the ABS resin layer 101. The primer layer 102 serves as an adhesive agent to prevent other layers from being removed or separated. The transparent layer 103 is laminated on the primer layer 102 and may be made of a light-transmitting transparent material. The metal printing layer 104 is laminated on the transparent layer 103 and is printed on the transparent layer 103 to provide a metallic texture. The thickness of the metal printing layer 104 or other kind of printing ink may be selected such that light can pass through the metal printing layer 104 even after the metal printing layer 104 is printed on the transparent layer 103. For example, as the metal printing layer 104, a film made of stainless steel may be printed on the transparent layer 103, e.g., to provide a visual effect of stainless steel texture. This enables light to transmit through the metal printing layer 104 and be visible by users. The clear coating layer 105 is laminated on the metal printing layer 104 and may be made of a transparent material capable of protecting the metal printing layer 104.

After the inlay film 100 is formed, the component disposing process may be performed. As illustrated in FIG. 3A, the inlay film 100 is disposed at one side (a first side) of a mold 210 and one or more light-transmitting transparent components 300 are disposed at the other side (a second side) of the mold 210.

In this regard, a predetermined pattern may be formed at the first side of the mold 210 in which the inlay film 100 is disposed. This pattern is imprinted on the inlay film 100 on an outer surface of the final article that is injection-molded according to the present embodiment (one-piece injection-molded article). Instead of attaching separate film to the inlay film 100 or forming a printing layer on the inlay film 100, the pattern is formed at the first side of the mold 210. Thus, when the inlay film 100 that is placed on the first side of the mold 210 is heated during an injection molding process, the ABS resin layer 101 of the inlay film 100 is melted and imprinted with a pattern groove 211 formed in the mold 210. Thereby, the pattern of the mold 210 is transferred to the inlay film 100. The pattern, which is to be displayed in the display unit 52, may be, for example, letters or symbols that indicate water or ice.

Light can transmit through the transparent components 300 so that various kinds of numerals or symbols indicating an operational state of the dispenser or the refrigerator can be displayed on the display unit 52. The transparent components 300 may be made of a transparent synthetic resin (plastic).

The locations of the transparent components 300 may be defined with reference to the position of a light source. The transparent components 300 are formed when the transparent components 300 are disposed at the second side of the mold 210.

After the component disposing process is completed, the one-piece injection molding process may be performed.

At the one-piece injection molding process, as illustrated in FIG. 3B, a resin may be injected into the mold 210 to form a molding 200 after the inlay film 100 and the transparent components 300 are disposed in the mold 210. The resin thus injected contacts the inlay film 100 and the transparent components 300 in the mold 210. As the resin is cured to form. the molding 200, the inlay film 100 and the transparent components 300 may be combined together and may be injection-molded as a one-piece article.

After the molding 200 is injection-molded, an injection-molded article having one body (hereinafter referred to as a “one-piece-molded article 400”) including the inlay film 100, the transparent components 300 and the cured resin is obtained.

As illustrated in FIG. 3C, at the removal process, the members constituting the mold 210 are separated to release and remove the one-piece-molded article 400 therefrom. Thereby, the one-piece-molded article 400 as shown in FIG. 3D can be made.

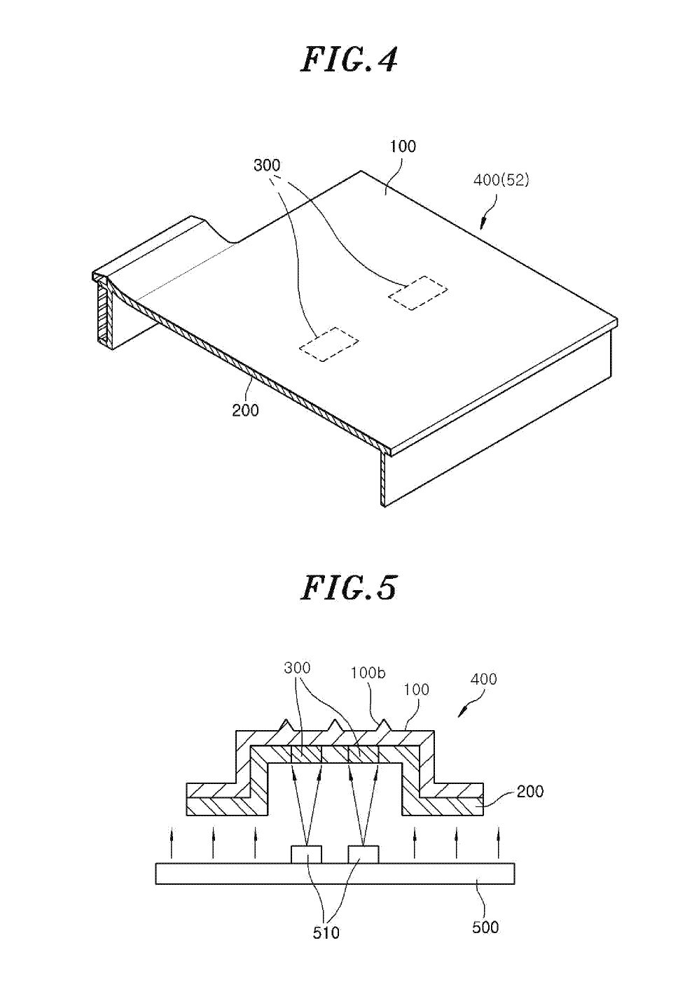

The following description refers to FIGS. 4 and 5.

FIG. 4 is a perspective view illustrating an exemplary display unit manufactured by the method illustrated in FIGS. 3A to 3D. FIG. 5 illustrates the exemplary process of assembling the display unit in FIG. 4 and a substrate provided with a light source.

In FIG. 3D, the compositions of the one-piece-molded article 400 are illustrated. In some embodiments, the one-piece-molded article 400 for the display unit 52 may have a form illustrated in FIG. 4. The inlay film 100 is disposed on the outer surface of the one-piece-molded article 400. The molding 200 formed by curing the injected resin is disposed in the inner side of the one-piece-molded article 400. The light-transmitting transparent components 300 may be disposed in certain positions of the molding 200.

As illustrated in FIG. 5, in the assembling process, the one-piece-molded article 400 and the substrate 500 may be assembled with the light source 510 facing the transparent components 300 of the one-piece-molded article 400.

As described above, the display unit 52 includes the inlay film 100, the molding 200 and the transparent components 300.

The inlay film 100 is disposed on the outer surface of the display unit 52.

The molding 200 is disposed at the inner side of the inlay film 100 and is integrally formed with the inlay film 100 through an injection molding process. The molding 200 is formed as the injected resin is cured.

The transparent components 300 are disposed in predetermined positions of the molding 200 to allow light emitted from the light source 510 installed at the inner side of the molding 200 to travel toward the inlay film 100 through the transparent components 300. The transparent components 300 may have a thickness preferably equal to or larger than the thickness of the molding 200 and may be integrally formed with the molding 200 through an injection molding process. In this manner, the transparent components 300 would not be covered by the resin injected in the injection molding process.

In this regard, a predetermined pattern 100b required in the display unit 52 may be integrally formed on the surface of the inlay film 100.

The display unit 52 according to the present embodiment may further include a substrate 500 assembled with the molding 200 and having the light source 510. The light source 510 faces the transparent components 300.

Thus, light emitted from the light source 510 may pass through the transparent components 300 and the inlay film 100 and thus be visible to a user.

Although exemplary embodiments of the present disclosure are described above with reference to the accompanying drawings, those skilled in the art will understand that the present disclosure may be implemented in various ways without changing the necessary features or the spirit of the present disclosure.

Therefore, it should be understood that the exemplary embodiments described above are not limiting, but only an example in all respects. The scope of the present disclosure is expressed by claims below, not the detailed description, and it should be construed that all changes and modifications achieved from the meanings and scope of claims and equivalent concepts are included in the scope of the present disclosure.

From the foregoing, it will be appreciated that various embodiments of the present disclosure have been described herein for purposes of illustration, and that various modifications may be made without departing from the scope and spirit of the present disclosure. The exemplary embodiments disclosed in the specification of the present disclosure do not limit the present disclosure. The scope of the present disclosure will be interpreted by the claims below, and it will be construed that all techniques within the scope equivalent thereto belong to the scope of the present disclosure.

What is claimed is:

1. A method of manufacturing a display unit for dispenser of a refrigerator, the method comprising:
forming an inlay film into a predetermined shape;
disposing the inlay film on a first side of a mold and disposing one or more transparent components on a second side of the mold;
injecting a resin into the mold for bonding the inlay film and the one or more transparent components to form a one-piece-molded article as the resin is cured; and
removing the one-piece-molded article from the mold, wherein the one-piece-molded article comprises the inlay film, the one or more transparent components and the resin.

2. The method of claim 1, wherein the forming the inlay film comprises:
placing film raw material on vacuum forming machine having a predetermined shape;
heating the film raw material to form the inlay film in the predetermined shape; and
trimming an edge of the inlay film.

3. The method of claim 2, wherein the trimming the edge comprises punching and removing the edge.

4. The method of claim 1, wherein the inlay film comprises:
an ABS resin layer;
a primer layer, laminated on the ABS resin layer, as an adhesive agent; and
a transparent layer laminated on the primer layer.

5. The method of claim 4, wherein the inlay film further comprises:
a metal printing layer laminated on the transparent layer, wherein the metal printing layer is operable to allow light to transmit therethrough; and
a clear coating layer laminated on. the metal printing layer and comprising a transparent material for protecting the metal printing layer.

6. The method of claim 1 further comprising heating the one-piece-molded article to form a pattern on a surface of the inlay film, wherein the first side of the mold comprises the pattern.

7. The method of claim 1 further comprising assembling a substrate comprising a light source with the one-piece-molded article, wherein the light source faces the transparent components.

8. A display unit for a dispenser of a refrigerator, the display unit comprising:
an inlay film disposed on an outer surface of the display unit, the inlay film having a predetermined shape;
a molding disposed at an inner side of the inlay film and integrally formed with the inlay film through an injection molding process; and
a transparent component having a thickness equal to or larger than a thickness of the molding, the transparent component being integrally formed with the molding through the injection molding process and configured to allow light to transmit therethrough.

9. The display unit of claim 8, wherein the inlay film comprises:
an ABS resin layer;
a primer layer, laminated on the ABS resin layer, as an adhesive agent; and
a transparent layer laminated on the primer layer and configured to allow light to transmit therethrough.

10. The display unit of claim 9, wherein the inlay film further comprises:
a metal printing layer laminated on the transparent layer, wherein the metal printing layer is operable to allow light to transmit therethrough; and
a clear coating layer laminated on the metal printing layer and made of a transparent material for protecting the metal printing layer.

11. The display unit of claim 8, wherein a predetermined pattern is formed on a surface of the inlay film.

12. The display unit of claim 8 further comprising a substrate assembled with the molding and comprising a light source, wherein the light source faces the transparent component.

13. A display unit for a dispenser of a refrigerator, the display unit comprising:
an inlay film disposed on an outer surface of the display unit, the inlay film having a predetermined shape;
a molding disposed at an inner side of the inlay film and integrally formed with the inlay film through an injection molding process; and
a transparent component having a thickness equal to or larger than a thickness of the molding, wherein the transparent component is integrally formed with the molding through the injection molding process and configured to allow light to transmit therethrough, and
wherein a predetermined pattern is formed on the inlay film.

14. The display unit of claim 13, wherein the inlay film comprises:
an ABS resin layer;
a primer layer, laminated on the ABS resin layer, as an adhesive agent; and
a transparent layer laminated on the primer layer and configured to allow light to transmit therethrough.

15. The display unit of claim 14, wherein the inlay film further comprises:
a metal printing layer laminated on the transparent layer, wherein the metal printing layer is operable to allow light to transmit therethrough; and
a clear coating layer laminated on the metal printing layer and made of a transparent material for protecting the metal printing layer.

10. The display unit of claim 13 further comprising a substrate assembled with the molding and comprising a light source, wherein the light source faces the transparent component.
